(19) United States
(12) Patent Application Publication
(10) Pub. No.: US 2014/0126755 A1
(43) Pub. Date: May 8, 2014

(54) MULTIMODAL HEADSET

(71) Applicant: Ira Strasberg, Richmond Hill (CA)

(72) Inventor: Ira Strasberg, Richmond Hill (CA)

(73) Assignee: Headbox LLC a corporation

(21) Appl. No.: 13/261,687

(22) PCT Filed: Aug. 25, 2011
(86) PCT No.: PCT/CA2011/000949

§ 371 Date: Jan. 7, 2014

Related U.S. Application Data
(60) Provisional application No. 61/344,584, filed on Aug. 26, 2010.

(51) Int. Cl. H04R 5/033

(52) U.S. Cl. CPC H04R 5/033
USPC 381/309

(57) ABSTRACT

The multimodal headset may include: a first earpiece including a first earphone speaker and external speaker; a second earpiece including a second earphone speaker and external speaker; a controller for operating the multimodal headset in at least three modes, the controller may include: a power switch; a speaker switch; an earphone amplifier circuit; a speaker amplifier circuit; and a power source, wherein the power source is positioned within the first or second earpiece; wherein the input signal is routed to the earphone speakers, bypassing the earphone amplifier circuit, when the power switch is in an off position, wherein the input signal is routed through the earphone amplifier circuit to the earphone speakers when the power switch is in an on position and the speaker switch is in an internal earpiece position, and wherein the input signal is routed through the speaker amplifier circuit to the external speakers when the power switch is in the on position and the speaker switch is in an external speaker position.

### RELATED APPLICATIONS

This application claims the benefit of U.S. Provisional Application No. 61/344,584, filed Aug. 26, 2010, which is hereby incorporated by reference in its entirety.

### FIELD OF THE INVENTION

This invention relates to a multimodal headset and, in particular to a multimodal headset that has earphone speakers and external speakers for allowing a user to listen to music or other sound recordings with or without wearing the headset.

### BACKGROUND OF THE INVENTION

Stereo headsets are well known in the art. Headsets are plugged into media players, such as an MP3 player and the like, to allow a user to personally enjoy an input signal such as sound recordings, music, audio books, and the like. Typical headsets comprise two earpieces which are placed into or over a user's ears. Conventional headsets may include a headband for housing the two earpieces and a jack for plugging into a media player. Headsets are typically provided to allow a user to listen to an input signal in privacy.

In some instances, a user may want to share the sound recording that he or she is listening to, with others. However, the volume (i.e. power) of the input signal provided to the earpieces may not allow for public broadcast. In other situations, the user may not want to place the earpieces over his or her ears, but would rather lay the headset on a surface or around the user's neck when broadcasting the input signal publicly. Furthermore, in some situations, a user may prefer enhanced audio, such as for example, boosted bass when listening to the input signal with the headset. Accordingly, there is a need for a stereo headset that allows a user to enjoy sound recordings in a variety of situations.

### SUMMARY OF THE INVENTION

Accordingly, it is an objection of the present invention to at least partially overcome some of the deficiencies of the prior art.

The present invention is directed to a multimodal headset which can be used in several different ways. The multimodal headset can be used as either headphones (i.e. for personal use) or as a pair of portable speakers, due to its four-speaker design. Two earphone speakers are used for internal sound and two external speakers are used for external sound. Furthermore, the two earphone speakers may be used with or without amplification.

The multimodal headset has many different uses. When operating with the earphone speakers, the multimodal headset allows a user to listen to an input signal, such as a sound recording, privately. However, when utilizing the external speakers, the user can listen to the input signal without impeding the ability to listen to other sources of sound or share the input signal with others. This added functionality may be ideal for a myriad of uses including: listening to music, talking on a mobile phone, portable gaming, connecting with a laptop or desktop computer, and the like. In addition, the multimodal headset is also operable with electronic instruments, such as an electric guitar.

In a preferred embodiment, the multimodal headset is configured with a built-in rechargeable lithium polymer battery, which can be recharged via an AC adapter to mini Universal Serial Bus (USB) plug, or a USB to mini USB plug. The built-in battery is integrated within the multimodal headset design. Furthermore, the battery is used to power the multimodal headset when amplification is used. When the multimodal headset is in passive operation (i.e. with no amplification), no power is drawn from the battery.

The multimodal headset is configured with a power switch, a speaker switch, an earphone amplifier circuit and a speaker amplifier circuit. The two switches and two amplifiers allow the multimodal headset to operate in at least three different modes.

In a preferred embodiment, the multimodal headset is operable in three modes. In a first or passive mode, the multimodal headset is passive with no power being drawn from the battery. However, the earphone speakers are still functional for use without amplification. The multimodal headset will operate in the passive mode when the power switch is in an OFF position.

In a second or amplified earphone mode, the earphone speakers are amplified. For example, the earphone speakers may be bass boosted to have stronger bass. A dedicated earphone amplifier circuit may be used. In this mode, the power switch must be in an ON position as power is drawn from the battery. Furthermore, the speaker switch must be in an internal earpiece position.

In a third or amplified external speaker mode, the external speakers are amplified. A dedicated external amplifier circuit may be used. In this mode, the power switch must be in the ON position, as power is drawn from the battery. Furthermore, the speaker switch must be on the external speaker position.

The battery is also configured to power a built-in lighting system which is used to identify which mode of operation, the multimodal headset is operating in. The lighting system may also indicate when the multimodal headset is charging and when the multimodal headset requires charging. The lighting system or indicating system may also provide indicators of what mode the multimodal headset is operating in, using different patterns or different colours of light to indicate different modes.

In one aspect, the present invention resides in a multimodal headset. The multimodal headset may include a headband having a first end and a second end; a first earpiece having a first casing mechanically coupled to the first end, the first earpiece comprising a first earphone speaker integrated with a first inward facing side and a first external speaker integrated with a first external facing side; a second earpiece having a second casing mechanically coupled to the second end and electrically coupled to the first earpiece, the second earpiece comprising a second earphone speaker integrated with a second inward facing side and a second external speaker integrated with a second external facing side; an input receptacle for receiving an input signal; a controller for operating the stereo headset in at least three modes, the controller may include: a power switch configured with an on position and an off position; a speaker switch configured with an internal earpiece position and an external speaker position; an earphone amplifier circuit electrically coupled to the first and second earphone speakers; a speaker amplifier circuit electrically coupled to the first and second external speakers; and a portable power source for powering the earphone amplifier circuit and the speaker amplifier circuit, wherein the portable power source is electrically coupled to the controller and is positioned within the first casing of the first earpiece or the second casing of the second casing of the second earpiece; wherein the input signal is electrically routed by the controller to the first and second earphone speakers, bypassing the earphone amplifier circuit, when the power switch is in the off position, wherein the input signal is electrically routed by the controller through the earphone amplifier circuit to the first and second earphone speakers when the power switch is in the on position and the speaker switch is in the internal earpiece position, and wherein the input signal is electrically routed by the controller through the speaker amplifier circuit to the first and second external speakers when the power switch is in an on position and the speaker switch is in the external speaker position.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1A shows a front profile of a multimodal headset in accordance with an embodiment of the present invention;

FIG. 1B shows a side profile of a multimodal headset in accordance with an embodiment of the present invention;

FIG. 1C shows an isometric profile of a multimodal headset in accordance with an embodiment of the present invention;

FIG. 1D shows a detachable headset cable for a multimodal headset in accordance with an embodiment of the present invention;

FIG. 2A shows a schematic diagram of an electronic circuit for a multimodal headset in accordance with an embodiment of the present invention;

FIG. 2B shows a schematic diagram of another electronic circuit for a multimodal headset in accordance with another embodiment of the present invention;

FIG. 3A shows an exploded view of a headset housing for a multimodal headset in accordance with an embodiment of the present invention; and

FIG. 3B shows an exploded view of a cable housing for a detachable headset cable for a multimodal headset in accordance with an embodiment of the present invention.

### DETAILED DESCRIPTION OF THE PREFERRED EMBODIMENTS

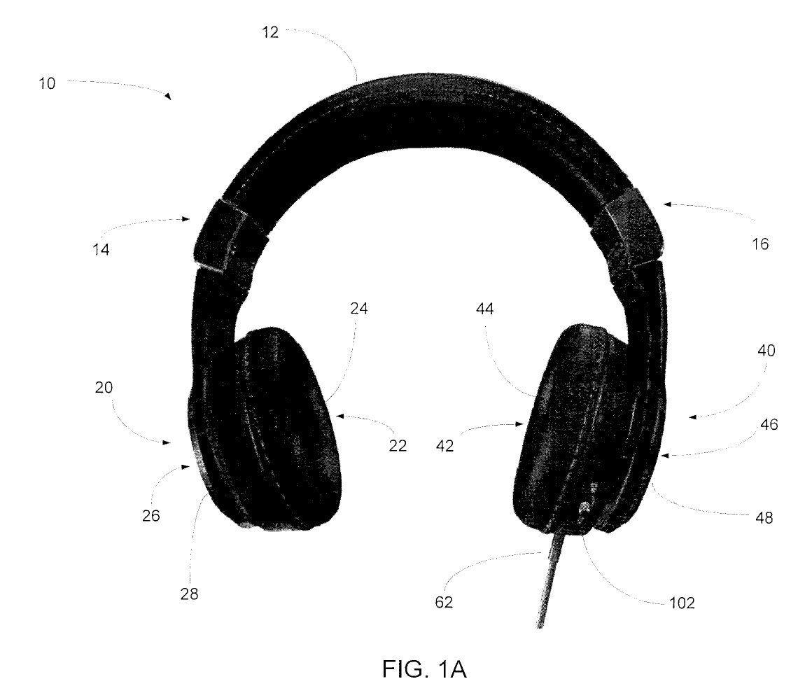

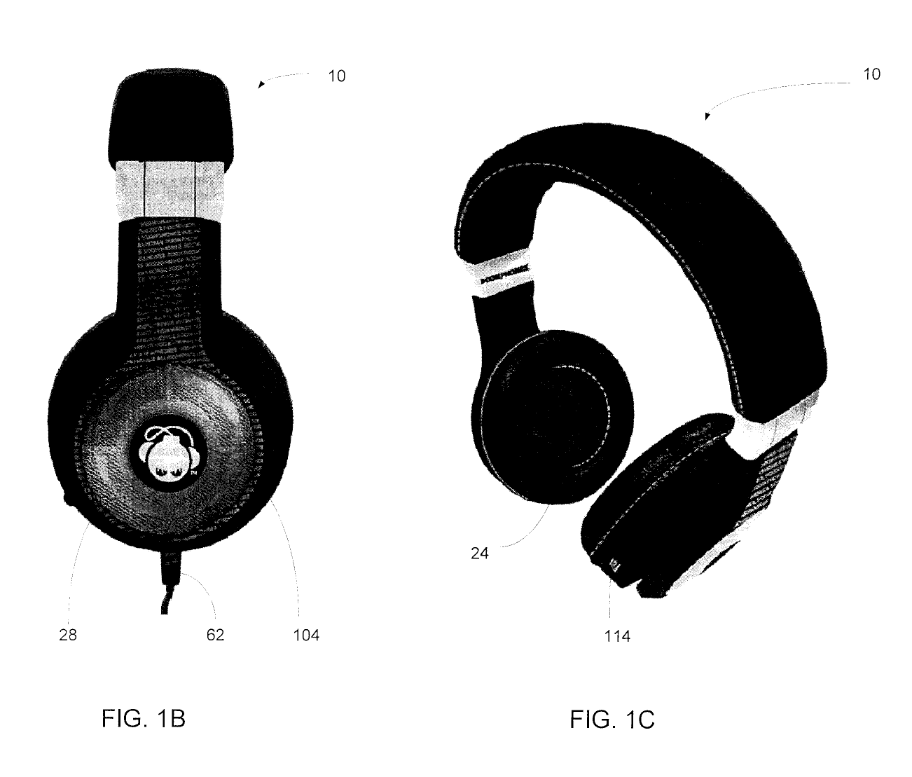

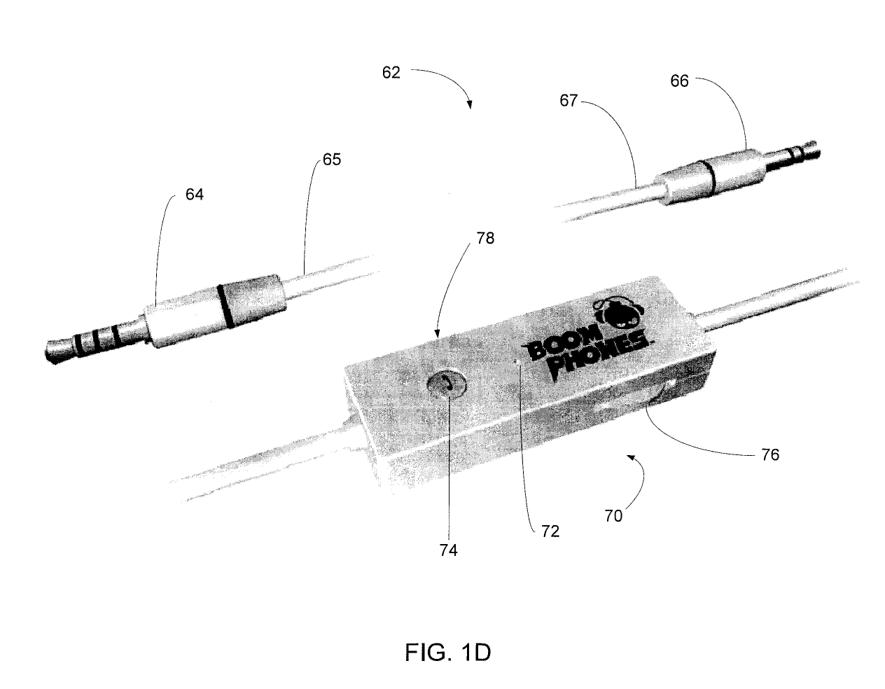

Reference is now made to FIG. 1A to FIG. 1D which illustrates a multimodal headset 10 in accordance with an embodiment of the present invention. The headset 10 is configured with a headband 12 having a first end 14 and a second end 16. The headset 10 is further configured with a first earpiece 20 having a first casing 21 mechanically coupled to the first end 14 and a second earpiece 40 having a second casing 41 mechanically coupled to the second end 16.

The first earpiece 20 is configured with a first inward facing side 22 configured with a first earphone speaker 24 and a first outward facing side 26 configured with a first external speaker 28. The first earpiece 20 may be pivotally connected to the first end 14 of the headband 12 such that the first earpiece 20 is operable to pivot relative to the headband 12.

Similarly, the second earpiece 40 is configured with a second inward facing side 42 configured with a second earphone speaker 44 and a second outward facing side 46 configured with a second external speaker 48. The second earpiece 40 may be pivotally connected to the second end 16 of the headband 12 such that the second earpiece 40 is operable to pivot relative to the headband 12. In some embodiments, the first and second earpieces 20, 40 may be pivoted such that normals to a surface of the first external speaker 28 and to a surface of the second external speaker 48 are operable to be directed in substantially the same direction. In this manner, the sound from the multimodal headset 10 will be projected in the same direction when the multimodal headset 10 is placed on a surface, such as a table.

In a preferred embodiment, the first external speaker 28 is housed underneath the first casing 21 on the first external side 26 of the first earpiece 20 and the second external speaker 48 is housed underneath the second casing 41 on the second external side 46 of the second earpiece 40. Furthermore, the speaker switch 104 is disposed over the center of either the first external speaker 28 or the second external speaker 48. As shown in FIG. 1B, the speaker switch 104 is located over the center of the first external speaker 28.

In operation, the multimodal headset 10 is operable to play an input signal (i.e. a sound or music signal) received from a detachable headset cable 62. As the multimodal headset 10 is in stereo, the input signal may be received on two channels (i.e. a left and a right channel). Once received, the input signal is operable to be outputted through either the first and second earphone speakers 24, 44 or the first and second external speakers 28, 48. Accordingly, the multimodal headset 10 is operable to play sound for both personal and public consumption in different modes of operation.

In FIG. 1D, a detachable headset cable 62 is shown for attaching the multimodal headset 10 to a media player (not shown), such as a portable music player or mobile phone. In other embodiments, the detachable headset cable 62 may connect to a computer, a gaming system or an electronic instrument, such as an electric guitar.

The detachable headset cable 62 is configured to include a media player plug 64 and a headset plug 66. Furthermore, the detachable headset cable 62 may also include a headset controller 70 connected to the media player plug 64 by a first cable 65 and connected to the headset plug 66 by a second cable 67. The headset controller 70 may have a microphone 72, an activate button 74, and a volume control means 76 enclosed within a cable casing 78.

In a preferred embodiment, the headset plug 66 is configured as a tip, ring, sleeve connector (TRS) or audio jack, and the like, which provides separate left and right audio channels to the multimodal headset 10. Furthermore, the media player plug 64 may also be configured as a TRS connector. However, in another preferred embodiment, the detachable headset cable 62 is configured to operate with a mobile phone or a computer. In this embodiment, the media player plug 64 is configured with an additional ring (i.e. as a TRRS connector) to connect the microphone 72 to the media player. Furthermore, when operating with a mobile phone, the user may listen to a phone call using either the earphone speakers 24, 44 or the external speakers 28, 48.

In operation, the headset controller 70 may hang from the multimodal headset 10 and allow the user to control the volume of the recording being played using the volume control means 76. Furthermore, if connected to a mobile telephone, the microphone 72 and the activate button 74 may be operable to record the user's voice and answer a call, respectively.

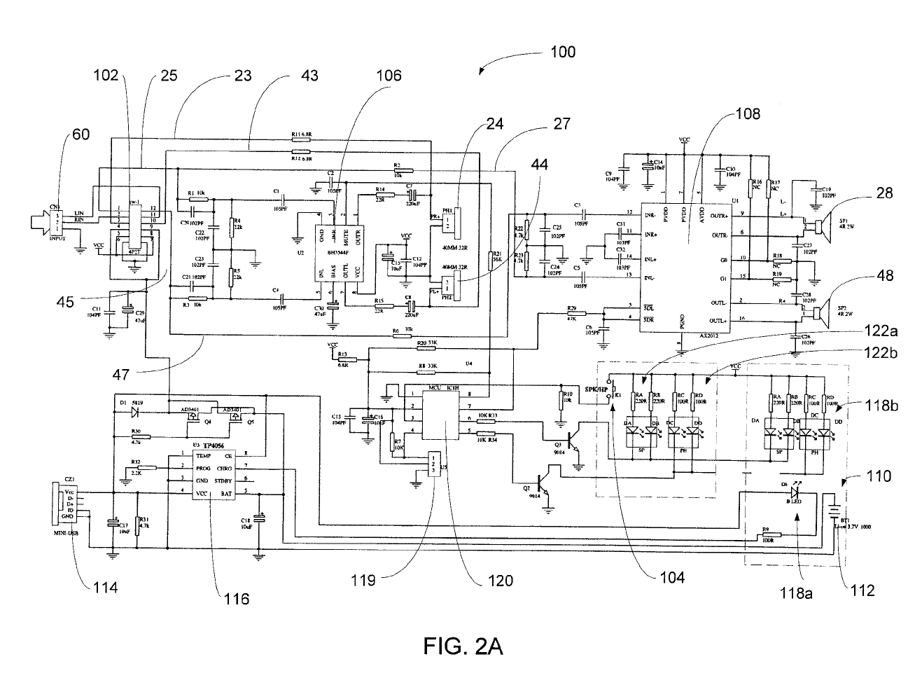

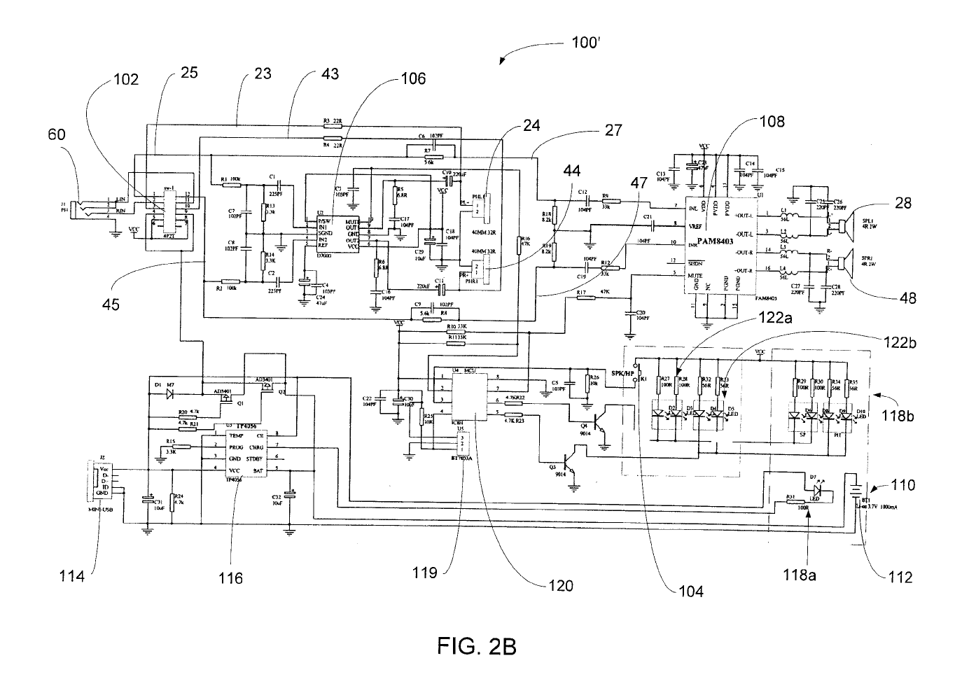

Referring briefly to FIG. 2A and FIG. 2B, a controller 100, 100′ in preferred embodiments (hereinafter referred to as controller 100) is configured with the multimodal headset 10 for operating the multimodal headset 10 in at least three modes. The controller 100 may be disposed within either the first casing 21 of the first earpiece 20 or the second casing 41 of the second earpiece 40, located within the multimodal headset 10.

Furthermore, the controller 100 may, in whole or in part, be configured on a printed circuit board (PCB). In addition, when located within either the first housing 21 or the second housing 41, the PCB configured with the controller 100 may be shaped to fit within the first earpiece 20 or the second earpiece 40, such as for example, in a circular shape (not shown). The circular shape may have a central aperture to provide passage for one of the external speakers 28, 48 and/or a speaker switch 104 located in the center of the external speakers 28, 48. In other embodiments, the controller 100 may be separated into two PCBs, each located in one of the first housing 21 or the second housing 41 of the multimodal headset 10.

The controller 100 is configured with a power switch 102, a speaker switch 104, an earphone amplifier circuit 106, a speaker amplifier circuit 108, and a portable power source 110. Based upon the positions of the power switch 102 and the speaker switch 104, an input signal received at an input receptacle 60 from the media player through the detachable headset 62 is electrically routed to one of the earphone speakers 24, 44 or external speakers 28, 48. Furthermore, when the power switch 102 is enabled, additional amplification of the input signal is conducted prior to output to the speakers 24, 28, 44, 48.

As described, the power switch 102 may be a mechanical switch. For example, it may be a quadruple pole, double throw (QPDT or 4P2T) switch. In this manner, two poles may be used for each of the left and right channel of the stereo input signal. Furthermore, one or both of the remaining poles may be configured to enable amplification of the input signal by providing power to the amplifier circuits 106, 108. In alternate embodiments, an electromechanical or electronic switch may be used.

In a preferred embodiment, the power switch 102 is operable to direct the input signal either directly to the earphone speakers 24, 44 or to one or both of the earphone amplifier circuit 106 and the speaker amplifier circuit 108. When in an “off” position, the power switch 102 routes the input signal directly from the input receptacle 60 to the earphone speakers 24, 44. The sound projected by the earphone speakers 24, 44 is driven by the input signal received at the input receptacle 60. When in an “on” position, additional amplification is utilized and power from the portable power source 110 is used to amplify the input signal received at the input receptacle 60 prior to output through either the earphone speakers 24, 44 or external speakers 28, 48.

The power switch 102 is operable to route power from the portable power source 110 to one or both of the two amplifier circuits 106, 108. When the input signal is routed directly to the earphone speakers 24, 44, i.e. when the power switch is in the “off” position, power to the amplifier circuits 106, 108 is disabled. In this manner, energy in the portable power source 110 is conserved when the multimodal headset 10 is not utilized to amplify the input signal.

The speaker switch 104 is configured with an internal earpiece position and an external speaker position. The operation of the multimodal headset 10 is determined by the speaker switch 104 when the power switch 102 is in the “on” position and configured to direct the input signal to one or both of the earphone amplifier circuit 106 and the speaker amplifier circuit 108. When the speaker switch 104 is in the internal earpiece position, the input signal is amplified by the earphone amplifier circuit 106 and the amplified signal is outputted by the earphone speakers 24, 44. When the speaker switch 104 is in the external speaker position, the input signal is amplified by the speaker amplifier circuit 108 and the amplified signal is outputted by the external speakers 28, 48. The controller 100 may incorporate a control circuit 120 to operate control over the at least three modes of operation.

Referring now to FIG. 2A and FIG. 2B in detail, the controller 100 is configured to allow the multimodal headset to operate in at least three modes. In a first mode or passive mode, the input signal is output by the earphone speakers 24, 44 without any external amplification. The input signal is received at the input receptacle 60 and routed directly to the earphone speakers 24, 44. In this manner, the volume of the outputted signal is driven by the magnitude of the received input signal. In a second mode or amplified earphone mode, the input signal is output by the earphone speakers 24, 44 with amplification. The input signal is routed through the earphone amplifier circuit 106, which is powered by the portable power source 110. In a third mode or amplified external speaker mode, the input signal is output by the external speakers 28, 48 with amplification. The input signal is routed through the speaker amplifier circuit 108, which is powered by the portable power source 110.

In some embodiments, the magnitude of the amplification of the input signal is fixed by the earphone amplifier circuit 106 and speaker amplifier circuit 108. In other embodiments, the magnitude of the amplification is adjustable. The multimodal headset 10 may have additional controls to vary the amplification of the amplifier circuits 106, 108. Other configurations of the controller 100 are possible.

In the passive mode, the input signal is received at the input receptacle 60 and routed to the earphones speakers 24, 44 along transmission lines 23, 43 when the power switch 102 is in an ‘off’ position. In this passive mode, no power is drawn from the portable power source 110 to amplify the input signal. Instead, the input signal is directly routed from the input receptacle 60 through the power switch 102 to the earphone speakers 24, 44, bypassing the earphone amplifier circuit 106 and the speaker amplifier circuit 108. In this manner, the multimodal headset 10 behaves as a standard pair of earphones with the volume of the input signal outputted by the earphones commensurate with the strength or magnitude of the received input signal. For example, if the multimodal headset 10 is connected to a portable media player, the magnitude or volume outputted by the earphone speakers 24, 44 will be determined by the strength of the input signal sent by the portable media player.

In the amplified earphone mode, the input signal is electrically routed by the power switch 102 along transmission lines 25, 45 into the earphone amplifier circuit 106. For example, the earphone amplifier circuit 106 may include a dedicated integrated circuit for amplifying the input signal such as a D7000 low voltage amplifier from Shenzhen Universal Micro-Electronics Company or a BH3544F headphone amplifier from ROHM Semiconductor. In a preferred embodiment, the earphone amplifier circuit 106 is configured to provide bass boosting (i.e. amplified bass). However, other forms of amplification are possible.

However, the earphone amplifier circuit 106 is only enabled when the speaker switch 104 is in the internal earpiece position. A signal may be sent from the control circuit 120 to enable or disable the earphone amplifier circuit 106. When the speaker switch 104 is in the internal earpiece position, the amplified signal outputted by the earphone amplifier circuit 106 is then transmitted to and outputted by the earphone speakers 24, 44. When the speaker switch 104 is in the internal earpiece position, the speaker amplifier circuit 108 is disabled, such as, for example, by being muted by the control circuit 120.

In the amplified external speaker mode, the input signal is electrically routed by the power switch 102 along transmission lines 27, 47 into the speaker amplifier circuit 108. For example, the speaker amplifier circuit 106 may include a dedicated integrated circuit for amplifying the input signal such as a PAM8403 Stereo Audio Amplifier from Power Analog Microelectronics, Inc., and the like (e.g. a CS8403 Stereo Audio Amplifier). In a preferred embodiment, the external amplifier circuit 108 is configured to amplify the input signal for output by the external speakers 28, 48.

However, the speaker amplifier circuit 108 is only enabled when the speaker switch 104 is in the external speaker position. A signal may be sent from the control circuit 120 to enable or disable the speaker amplifier circuit 108. When the speaker switch 104 is in the external speaker position, the amplified signal outputted by the speaker amplifier circuit 108 is then transmitted to and outputted by the external speaker 28, 48. When the speaker switch 104 is in the external speaker position, the earphone amplifier circuit 106 is disabled, such as, for example, by being muted by the control circuit 120.

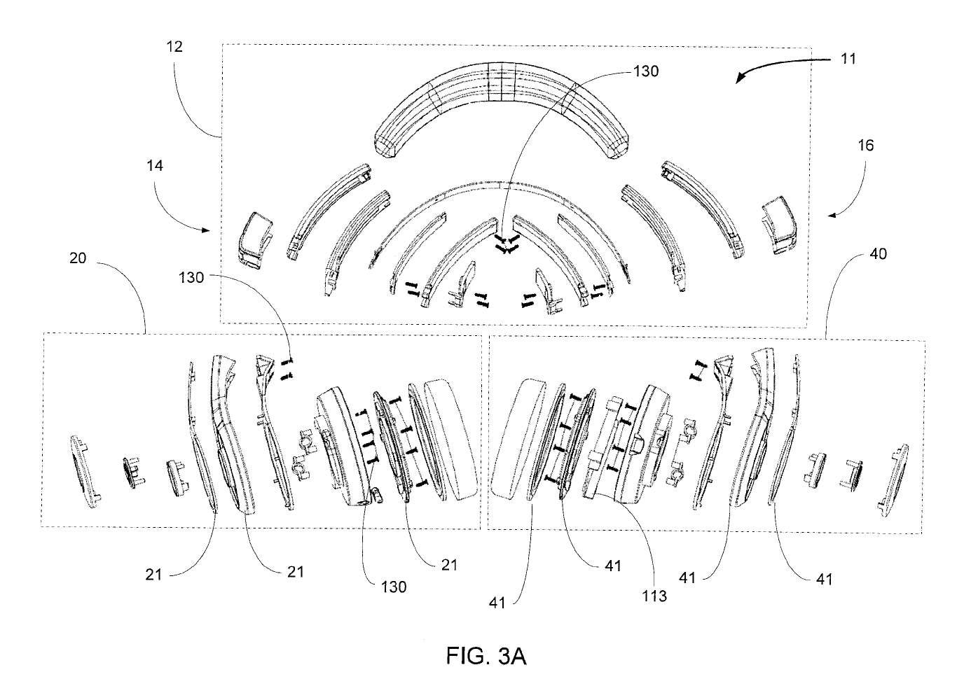

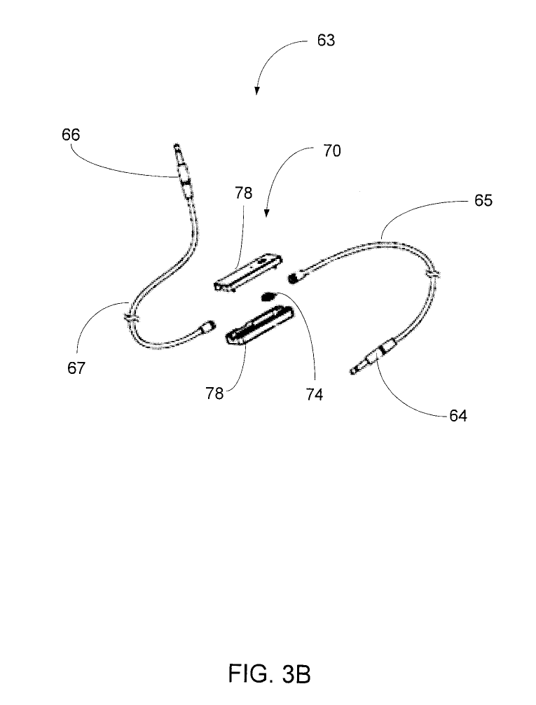

As described above, the amplifier circuits 106, 108 are powered by the portable power source 110. For example, a battery 112 may be used such as a rechargeable lithium polymer battery and the like. The portable power source 110 is configured as part of the multimodal headset 10 and is located within the first earpiece 20 or the second earpiece 40 of the headset 10. For example, referring briefly to FIG. 3A, the portable power source 110 is disposed inside the battery box 113 located within the second earpiece 40, between different components of the second casing 41. When the power switch 102 is in the on position, the portable power source 110 is operable to supply power to the earphone amplifier circuit 106 and the speaker amplifier circuit 108.

In a preferred embodiment, the battery 112 of the portable power supply 110 is rechargeable while the battery 112 is integrated within the multimodal headset 10. A charging socket 114 is provided on the headset 10, such as, for example, on either the first or second casing 21, 41 and the like, to receive a power plug (not shown) for charging the battery 112. In some embodiments, the charging socket 114 and the power plug may universal serial bus (USB) devices and in a preferred embodiment, mini USB devices.

The controller 100 may further comprise a charging circuit 116 to facilitate and monitor the recharging of the battery 112 while positioned within the multimodal headset 10. Furthermore, the controller 100 and/or control circuit 120 may provide a charging indicia 118a for indicating when the battery 112 is being charged and/or when charging is complete. For example, a coloured (e.g. blue) light emitting diode (LED) may be used. In addition, a charging needed indicia 118b may be configured to indicate (e.g. via flashing in a specific colour, etc.), that the portable power supply 110 requires charging. To monitor the voltage of the portable power source 110, the controller 100 and/or control circuit 120 may incorporate a power source indicator circuit 119 to monitor when the portable power source 110 requires charging and to activate the charged needed indicia 118b, accordingly.

In some embodiments, the multimodal headset 10 may be operated with external power when the power plug is connected to the charging socket 114 and is charging the battery 112. The charging circuit 116 may be configured to route power to the amplifier circuits 106, 108 when the power plug is connected to the charging socket 114. Furthermore, the charging circuit 116 may monitor the portable power source 110 and determine when charging is complete. The charging circuit 116 may stop charging the portable power source 110 when the charging circuit 116 has determined that charging the portable power source 110 is complete.

In a preferred embodiment, the controller 100 is configured to provide indicia of what mode the multimodal headset 10 is operating in. For example, the control circuit 120 may be configured to operate one or more LEDs, and the like, for indicating what mode the multimodal headset 10 is operating in. For example, referring to FIG. 2B, the control circuit 120 is configured to operate mode indicators 122a and 122b. In a preferred embodiment, the mode indicators 122a are enabled to indicate that the multimodal headset 10 is operating in the internal earphone mode. Similarly, the mode indicators 122b are enabled to indicate that the multimodal headset 10 is operating in the external speaker mode. Different colours (e.g. white and red) may be used to differentiate mode indicators 122a, 122b.

Referring now to FIG. 3A, an exploded view of the headset housing 11 for a multimodal headset 10 is shown. The headset housing 11 may be configured with a mixture of components, including injection-molded plastics, foams, metallics, and the like. In a preferred embodiment, the headset housing 11 includes the headband 12, including the first end 14 and second end 16, and the first earpiece 20 and the second earpiece 40.

As shown in FIG. 3A, the first earpiece 20 includes a plurality of injection-molded components comprising the first casing 21. Similarly, the second earpiece 40 includes a plurality of injection-molded components comprising the second casing 41. The different pieces of the headset housing may be held together with screws 130. Alternatively, different attachment means may be used, such as adhesives, tapes, other mechanical couplings, and the like.

The electronic components (not shown) such as the controller 100 shown in FIG. 2A and FIG. 2B are configured to be placed within the headset housing 11. For example, the controller 100 and the portable battery source 110 are both disposed within the headset housing 11. Furthermore, the portable power source 110 (i.e. battery 112) may be located within the battery box 113, shown integrated within the second earpiece 40, and within the second casing 41.

In some embodiments, the battery 112 may be easily removable from the battery box 113. In other embodiments, the battery 112 is rechargeable and fixed inside the headset housing 113.

Moreover, the transmission lines 23, 25, 27, 43, 45, 47 connecting the input receptacle 60 to the amplifier circuits 106, 108 and the amplifier circuits 106, 108 and to the earphone speakers 24, 44 and the external speakers 28, 48 may be wired throughout the headset housing 11. Other headset housing 11 configurations are also possible.

FIG. 3B illustrates a cable housing 63 for a detachable headset cable 62 in a preferred embodiment. The cable housing 63 includes the media player plug 64 and the headset plug 66 connected to the cable casing 78 of the headset controller 70 by the first cable 65 and second cable 67, respectively. The headset controller 70 further includes the activate button 74.

The cable housing 63 is operable to protect the electronic components (not shown) connecting the media player to the multimodal headset 10, including the microphone 72 and other electronic components (e.g. transmission wires) required to route an input signal to the input receptacle 60.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

The embodiments of the invention in which an exclusive property or privilege is claimed is defined as follows:

1. A stereo headset comprising:
a headband having a first end and a second end;
a first earpiece having a first casing mechanically coupled to the first end, the first earpiece comprising a first earphone speaker integrated with a first inward facing side and a first external speaker integrated with a first external facing side;
a second earpiece having a second casing mechanically coupled to the second end and electrically coupled to the first earpiece, the second earpiece comprising a second earphone speaker integrated with a second inward facing side and a second external speaker integrated with a second external facing side;
an input receptacle for receiving an input signal;
a controller for operating the stereo headset in at least three modes, the controller comprising:
a power switch configured with an on position and an off position;
a speaker switch configured with an internal earpiece position and an external speaker position;
an earphone amplifier circuit electrically coupled to the first and second earphone speakers;
a speaker amplifier circuit electrically coupled to the first and second external speakers; and
a portable power source for powering the earphone amplifier circuit and the speaker amplifier circuit, wherein the portable power source is electrically coupled to the controller and is positioned within the first casing of the first earpiece or the second casing of the second casing of the second earpiece;
wherein the input signal is electrically routed by the controller to the first and second earphone speakers, bypassing the earphone amplifier circuit, when the power switch is in the off position,
wherein the input signal is electrically routed by the controller through the earphone amplifier circuit to the first and second earphone speakers when the power switch is in the on position and the speaker switch is in the internal earpiece position, and
wherein the input signal is electrically routed by the controller through the speaker amplifier circuit to the first and second external speakers when the power switch is in the on position and the speaker switch is in the external speaker position.

2. The stereo headset of claim 1, wherein the first external speaker is housed underneath the first casing on the first external side of the first earpiece and the second external speaker is housed underneath the second casing on the second external side of the second earpiece, wherein one of the first casing and the second casing is configured with the speaker switch disposed over the center of either the first or the second external speaker.

3. The stereo headset of claim 1, wherein the portable power source comprises a rechargeable battery and wherein the controller further comprises a charging socket for accepting a plug to charge the rechargeable battery while the rechargeable battery is positioned within the stereo headset.

4. The stereo headset of claim 3, wherein the controller further comprises charging indicia for indicating when the rechargeable battery requires charging.

5. The stereo headset of claim 3, wherein the charging socket is a mini universal serial bus (USB) socket and the plug is a mini USB plug.

6. The stereo headset of claim 1, wherein the controller further comprises an electronic indicia for indicating which of the at least three modes the stereo headset is operating in.

7. The stereo headset of claim 1, wherein the stereo headset further comprises a detachable headset cable for mating with the input receptacle, wherein the headset cable is operable to provide the input signal to the stereo headset.

8. The stereo headset of claim 7, wherein the detachable headset cable comprises a microphone such that the stereo headset is operable with an electronic device.

9. The stereo headset of claim 8, wherein the electronic device is a mobile phone.
